(19) United States
(12) Patent Application Publication
(10) Pub. No.: US 2005/0034964 A1
(43) Pub. Date: Feb. 17, 2005

(54) Detect switch having a smoothly pivoting actuator

(76) Inventor: Ocean H. R. Zhou, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/917,767

(22) Filed: Aug. 13, 2004

(30) Foreign Application Priority Data
Aug. 13, 2003 (TW) 92214634

(51) Int. Cl. H01H 1/36

(52) U.S. Cl. 200/252

(57) ABSTRACT

A detect switch (100) includes a cover (2), a spring (3), a slider (4), a pair of movable contacts (5), a dielectric base (6) having a post (611) projecting from a bottom wall (61), an actuator (7) and a number of fixed contacts (8). The cover is formed from a planar metal sheet and is substantially rectangular and has a protrusion downwardly projecting therefrom and defining socket (21) therein. The slider defines an elongate trough (41) in an upper surface thereof for receiving the spring. The movable contacts are mounted under the slider and each have an arch-shaped configuration. The dielectric base has a periphery wall enclosing around the bottom wall and a cutout (621) defined through the periphery wall. The actuator comprises an upright columnar main body, a stopper arm (71), an actuating arm (72) and a guiding camber (74).

### CROSS-REFERENCE TO RELATED APPLICATION

This application is related to a co-pending patent application entitled “DETECT SWTICH HAVING A SMOOTHLY PIVOTING ACTUATOR” invented by the same inventor, filed on the same date, and assigned to the same assignee of the present invention.

### BACKGROUND OF THE INVENTION

1. Field of the Invention

The present invention relates to a switch, and particularly to an electric switch for detection.

2. Description of Prior Art

U.S. Pat. No. 5,369,238 discloses a spring-return switch. The switch comprises: a case, a common contact and a transfer contact respectively embedded in opposite inner wall of the case, a slider supported for vertical movement within the case and integrally provided with an operating rod, a resilient contact held by the slider and having a base portion held by the slider, a first contact arm in continuous contact with the common contact and a second contact arm to be brought into contact with or to be separated from the transfer contact, and a return spring biasing the slider upward so that the slider is pressed resiliently against the inner surface of the upper wall of the case. The operating rod is dislocated from the center of the slider toward the transfer contact so that most part of pressure applied to the operating rod to depress the slider is exerted on the second contact arm of the resilient contact.

However, the operating rod just presses on one side of the slider, the biasing of stress may lead to the shave of the slider in operation, which may effect the steady operation of the switch. The unbalance of the slider may lead to the operating rod endure the pressure and also the stress acted by the walls of the base. The operating rod tends to be worn out after a period of use.

### BRIEF SUMMARY OF THE INVENTIN

A primary object of the present invention is to provide a simple switch having an actuator which is capable of smoothly pivoting therein.

To achieve the object, a simple switch comprises a base, a cover, a plurality of fixed contacts, a pair of movable contacts, a slider, a spring and an actuator. A post is defined in the base, and a concave is defined in the cover corresponding to the post. The cover engages for the base and forms a cavity there. The fixed contacts retain in the base, and the slider is mounted on it. The spring engages with the slider to enable the move of the slider. The movable contacts are mounted on the fixed contacts, which move with the slider following the action of the actuator and contact with the fixed contacts in different manners. The actuator is coupled with the post defined in the base.

To compare with the present technology, the merit of this invention defines a plurality of actuator arms that define different length. When the actuator is in different statuses, the longer arm and the shorter arm may endure different stress, and abrasion may be different, so it's more durable than normal actuator arm.

### BRIEF DESCRIPTION OF THE DRAWINGS

FIG. 1 is a perspective view of the present switch;

FIG. 2 is an exploded view of the present switch of FIG. 1;

FIG. 3 is a partially assembled view of the switch of FIG. 1;

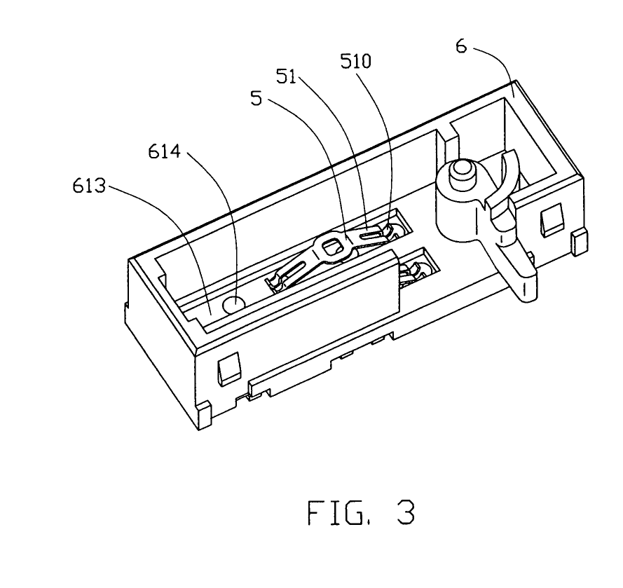

FIG. 4 is an assembled view of schematically elements of the present switch of FIG. 1;

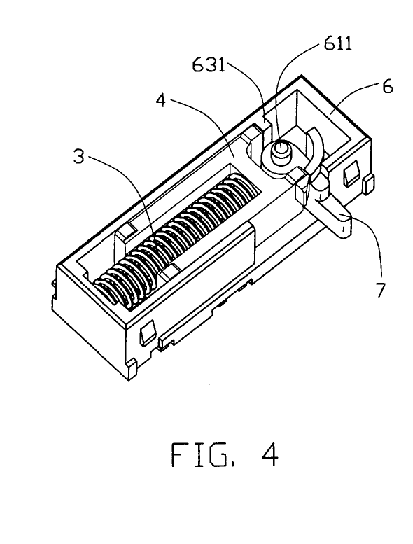

FIG. 5 is a perspective view of the slider of the present switch of FIG. 1; and

FIG. 6 is a perspective view of the slider of the switch of the FIG. 1, showing the bottom surface of the slider.

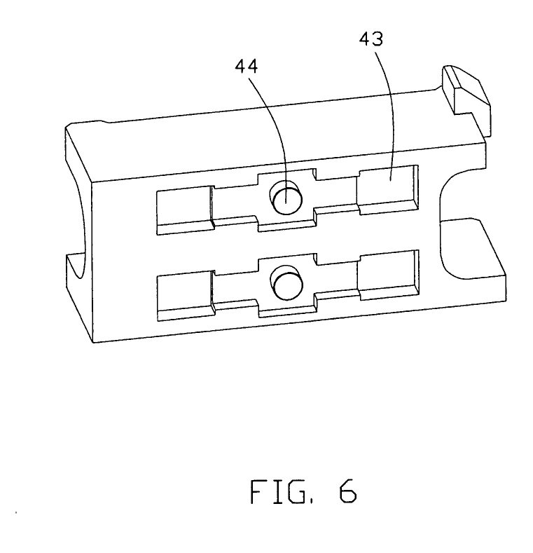

### DETAILED DESCRIPTION OF THE INVENTION

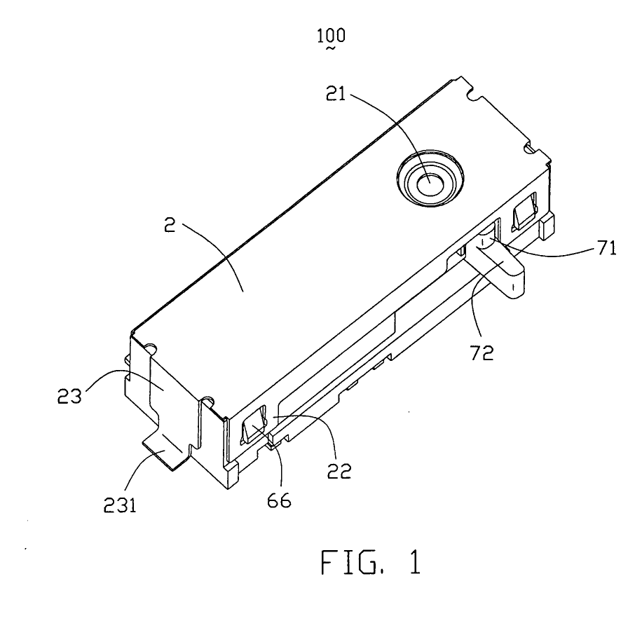

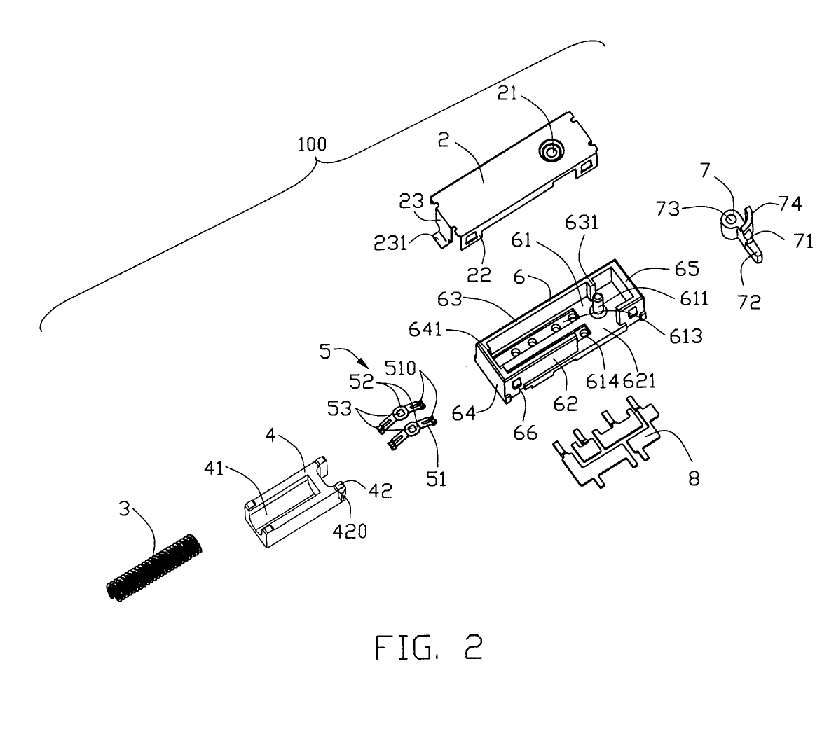

Referring to FIGS. 1 and 2, a detect switch comprises a cover 2, a spring 3, a slider 4, a pair of movable contacts 5, a dielectric base 6 having a post 611, an actuator 7 and a plurality of fixed contacts 8.

The dielectric base 6 has a substantially rectangular configuration and comprises a bottom wall 61. A periphery wall extends upwardly and encloses around the bottom wall 61. The periphery wall comprises opposite front and rear walls 62 and 63 and opposite left and right sidewalls 64 and 65. A post 611 upwardly projects from the bottom wall 61 and is adjacent to the right sidewall 65. A pair of elongate grooves 613 is defined in an inner surface of the bottom wall 61 and extends from the left sidewall 64 toward the post 611. The grooves 613 are parallel to the front and rear walls 62 and 63. Two rows of contacting holes 614 are defined through the bottom wall 61 and are communicate with corresponding grooves 613. A stopper wall 631 forwardly projects from the rear wall 63 toward the post 611. A plurality of fixing projections 66 project from outer surfaces of the front and rear walls 64, 65. A concave 641 is defined in the left wall 64.

Also referring to FIG. 2, the cover 2 is formed from a planar metal sheet and is a substantially rectangular. The cover 2 comprises a protrusion (not labeled) downwardly projecting therefrom. The protrusion is arranged corresponding to post 611 and defines a socket 21 in a lower surface thereof for engaging with a top end of the post 611. A plurality of tabs 22 extends downwardly from opposite front and rear edges of the cover 2. Each tab 22 defines a fixing hole (not labeled) for engaging with a corresponding fixing projection 66. A pair of legs 23 extends downwardly from opposite side edges of the cover 2 and each comprise a foot 231 outwardly and horizontally extending from a lower end thereof.

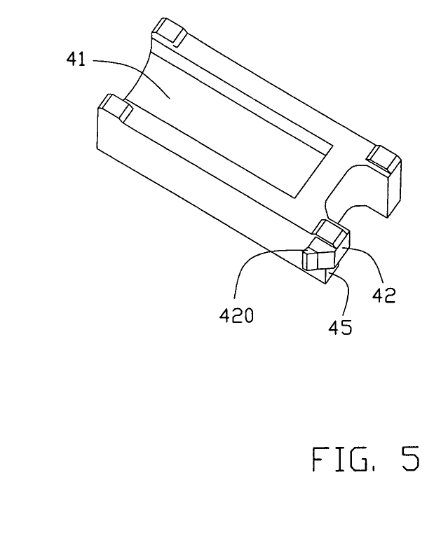

Referring to FIGS. 2 and 5, the slider 4 is substantially cubic and is received in the dielectric base 6. The slider 4 defines an elongate trough 41 in an upper surface thereof for receiving the spring 3. The trough 41 extends through a left surface of the slider 4 and is parallel to the front and rear walls 62 and 63. A pair of arms 42 projects rightward from a right end of the slider 4. A projection 420 forwardly projects from one of the arms 42, a step 45 is formed below that arm 42. A pair of elongate recesses 43 are defined in a bottom surface of the slider 4 and are arranged corresponding to the grooves 63. A pair of holding poles 44 is formed in corresponding recesses 43 and project downwardly beyond the recesses 43.

The movable contacts 5 are mounted under the slider 4 and each have an arch-shaped configuration. Each contact 5 comprises a central rectangular holding portion 52. The holding portion 52 defines a holding opening 53 therethrough for engaging with a corresponding holding pole 44. Two pairs of bifurcate contact finger 51 extend from opposite sides of the holding 52, respectively. The contact fingers 51 are substantially parallel and each has a convex contact portion 510 downwardly extending from a distal end thereof.

Referring to FIG. 2, the actuator 7 comprises an upright columnar main body, a stopper arm 71, an actuating arm 72 and a guide camber 74. The columnar main body defines a through hole 73. The through hole 73 is cylindrical and is concentric and is concentric with the main body. The stopper arm 71 is built on the actuating arm 72. The guiding camber 74 extends from the stopper arm and the actuating arm 71 and 72 and partially circles around the main body. The guiding camber 74 is a small segment of a cylinder and has the same central axis as the main body.

In assembly, the fixed contacts 8 are mounted a lower surface of the bottom wall 61 with distal ends exposed upwardly through the contacting holes 614. The through hole 73 of the actuator 7 engages with the post 611 with a top end of the post 611 upwardly extending beyond the through hole 73. The actuator arm 72 extends beyond the front wall 62 of the base 6 through the cutout 621 and abuts against the front wall 62 of the base 6. The guiding camber 74 has an outer periphery abutting against the front wall 62. The holding openings 53 of the movable contacts 5 engage with the corresponding holding poles 44. The slider 4 holding the movable contacts 5 is mounted on the bottom wall 61 of the dielectric base 6 with the arms 42 respectively abutting against the stopper wall 631 and the actuating arm 72. The contacts 5 are positioned in corresponding grooves 613 with the convex portions 510 extending through selected contacting holes 64 to contact with selected fixed contacts 8.

As the post 61 is integrated with the dielectric housing 6, the actuator 7 can remain still with the post 61 in operation and can prevent from shaving, which may lead to mistakes of placing.

In operation, the actuator 7 is trigged and pivots on the post 61, which in turn push the slider 4 to move away from the stopper wall 631 until the projection 420 abuts left wall of the cutout 621 in the front wall 62. The movable contacts 5 are mounted under the slider 4 and can move together. The different place of the movable contacts 5, which is droved by the slider 4 and determined by the press acting on the actuator 7, results in different electric statuses. One end of the spring 3 is caught in the concave 641 and the main body of the spring 3 is embodied in the trough 41. If released, the spring 3 restores to the normal status, which in turn forces the slider 4 to restore until the arm abuts the stopper wall 631.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

1. A detect switch comprising:
a dielectric base having a bottom wall and a periphery wall enclosing around the bottom wall, a cutout being defined through the periphery wall;
a plurality of fixing contacts mounted on the bottom wall of the base;
a cover engaging with said dielectric base;
a spring;
an actuator having a main body pivotally held in the dielectric base, an actuate arm extending from the main body, and a guiding camber partially around the main body and having a same central axis as the main body, the actuating arm outwardly extending through the cutout of the base;
a pair of movable contacts each comprising a holding portion and a convex contact portion extending toward the bottom wall for electrically connecting with one of the fixing contacts; and
a slider movably mounted on the bottom wall of the dielectric base and actuated by the actuator, the slider holding the holding portion of the movable contact on a bottom surface thereof, the slider comprising an end abutting against the actuator, the slider defining a trough receiving the spring therein.

2. The detect switch as claimed in claim 1, wherein said dielectric housing forms a post on the bottom wall and said main body of said actuator defines a through hole engaging with said post.

3. The detect switch as claimed in claim 2, wherein said post has a small column on the upper surface and forms a step, said small column engaging with said concave and said step abutting said protrusion.

4. The detect switch as claimed in claim 1, wherein the cover defines a protrusion and defines a socket therein for engaging with the post of the dielectric base.

5. The detect switch as claimed in claim 1, wherein said bottom wall has an elongate groove defined therein, said movable contacts moving along said groove.

6. The detect switch as claimed in claim 5, wherein the bottom wall defines a plurality of contacting holes.

7. The detect switch as claimed in claim 6, wherein said movable contacts are parallel each other, said contact portions being formed at distal ends thereof, said contact portions contacting with said fixed contacts through said contacting holes.

8. The detect switch as claimed in claim 1, wherein the guiding camber extends from the actuate arm and partially encircles around the main body, and the guiding camber is a small segment of a cylinder.

9. A switch comprising:
a dielectric housing;
a plurality of fixed contacts disposed in the housing;
a carrier moveably disposed in the housing and carrying at least one moveable contact thereon for engaging the fixed contacts; and
an actuator moveably mounted to the housing; wherein
said actuator defines a first engaging section and second engaging section respectively engaged with different corresponding portions of the carrier when said actuator is moved relative to the housing to actuate the carrier to move relative to the housing simultaneously, under a condition that said first and second engaging sections experience different engagement periods in each engagement cycle, respectively.

10. The switch as claimed in claim 9, wherein said carrier is moved linearly.

11. The switch as claimed in claim 9, wherein said different engagement periods are overlapped with each other.

12. The switch as claimed in claim 9, wherein said actuator is pivotally moved relative to the housing.

13. The switch as claimed in claim 12, wherein said first engaging section and said second engaging section are arranged at different axial positions of the actuator.

14. The switch as claimed in claim 12, wherein the carrier is moved linearly.

15. The switch as claimed in claim 14, wherein said carrier is moved in a first direction and said actuator is pivotal abut an axis along a second direction perpendicular to said first direction.

16. The switch as claimed in claim 9, further including a biasing device to urge the carrier toward the actuator.

17. The switch as claimed in claim 9, wherein one of said first engaging section and said second engaging section is longer than the other to also function as an operation handle.

18. The switch as claimed in claim 9, wherein one of said first engaging section and said second engaging section constantly engages the corresponding portion of the carrier during each engagement cycle.
